(19) United States
(12) Patent Application Publication
(10) Pub. No.: US 2015/0178036 A1
(43) Pub. Date: Jun. 25, 2015

(54) VIDEO OUTPUT DEVICE, INFORMATION PROCESSOR, AND METHOD

(71) Applicants: KABUSHIKI KAISHA TOSHIBA, Tokyo (JP); Toshiba Lifestyle Products & Services Corporation, Tokyo (JP)

(72) Inventor: Kunihiko KAWAHARA, Hamura-shi Tokyo (JP)

(21) Appl. No.: 14/328,306

(22) Filed: Jul. 10, 2014

Related U.S. Application Data
(60) Provisional application No. 61/919,957, filed on Dec. 23, 2013.

(51) Int. Cl. G06F 3/14; H04N 5/44; H04N 9/64

(52) U.S. Cl. CPC G06F 3/1446; H04N 9/64; H04N 5/44

(57) ABSTRACT

According to an embodiment, a video output device for example includes a plurality of terminals, an output module, an input module, a reception module, and an extraction module. The terminals are configured to be connected to a plurality of monitors. The output module is configured to output first images different for each of the terminals. The input module is configured to input video. The reception module is configured to receive, from an information processor, a display range of the video of each of the monitors. The display range is in accordance with a positional relation between the monitors specified based on the first images displayed on the monitors. The extraction module is configured to extract a part of the video within the display range of the each of the monitors. The part of the video is to be output from the output module via the terminals.

### CROSS-REFERENCE TO RELATED APPLICATIONS

This application claims the benefit of U.S. Provisional Patent Application No. 61/919,957, filed Dec. 23, 2013. The content of the application is incorporated herein by reference in their entirety.

### FIELD

Embodiments described herein relate generally to a video output device, an information processor, and a method.

### BACKGROUND

Conventionally, there has been proposed a technique in which one image is output to a plurality of monitors so as to display the image in a large size. Accordingly, a user manually performs a setting for displaying a partial video, which is obtained by dividing one video, on each of the monitors. Therefore, there has been a large operation burden.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a video output device and an information processor according to a first embodiment;

FIG. 2 is an exemplary diagram of a test pattern image output by an output module to a monitor, in the first embodiment;

FIG. 3 is an exemplary diagram illustrating rotation of the test pattern image output by the output module to the monitor, in the first embodiment;

FIG. 4 is an exemplary diagram of the test pattern image output by an output module to the monitor, according to a modification;

FIG. 5 is an exemplary diagram illustrating transition of processing performed by the information processor in the first embodiment;

FIG. 6 is an exemplary flowchart of a processing until an image is output in the video output device and the information processor in the first embodiment;

FIG. 7 is an exemplary diagram illustrating transition of processing performed by an information processor according to a second embodiment;

FIG. 8 is an exemplary flowchart of a processing until an image is output in the video output device and the information processor in the second embodiment;

FIG. 9 is an exemplary diagram in which pattern images output by an output module are displayed by the monitors, according to a modification of the second embodiment;

FIG. 10 is an exemplary diagram of adjusting inclination based on an image acquired by an image acquiring module in an information processor according to a third embodiment;

FIG. 11 is an exemplary diagram of adjusting inclination based on the image acquired by the image acquiring module in an information processor in a first modification of the third embodiment; and

FIG. 12 is an exemplary diagram of adjusting inclination based on the image acquired by the image acquiring module in an information processor in a second modification of the third embodiment.

### DETAILED DESCRIPTION

In general, according to an embodiment, a video output device comprises a plurality of terminals, an output module, an input module, a reception module, and an extraction module. The terminals are configured to be connected to a plurality of monitors. The output module is configured to output first images different for each of the terminals. The input module is configured to input video. The reception module is configured to receive, from an information processor, a display range of the video of each of the monitors. The display range is in accordance with a positional relation between the monitors specified based on the first images displayed on the monitors. The extraction module is configured to extract a part of the video of the display range of the each of the monitors. The part of the video is to be output from the output module via the terminals.

In general, according to an embodiment, an information processor comprises an input module and a transmission module. The input module is configured to input an acquired image acquired by acquiring an image of a plurality of monitors when the monitors are displaying first images different for each of the monitors. The transmission module is configured to transmit, to a video output device connectable to the monitors, a display range of video of each of the monitors. The monitors are for displaying the video when used in combination. The display range is set based on a relative positional relation between the monitors specified based on the first images displayed within the acquired image.

### First Embodiment

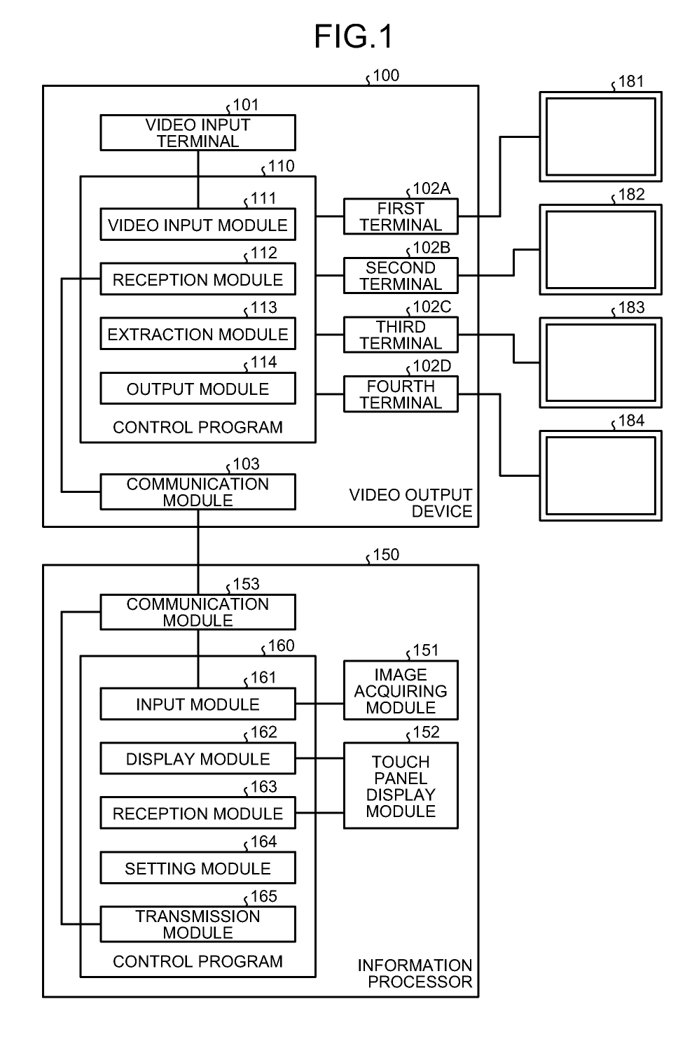

FIG. 1 is a block diagram of a video output device 100 and an information processor according to a first embodiment. In an example illustrated in FIG. 1, a display system is constructed by combining monitors 181 to 184 in a free arrangement and a free direction (rotation). A partial video extracted from a video is output from each of the monitors 181 to 184 that are constructed as the display system.

In the example illustrated in FIG. 1, the video output device 100 divides input video for each of the monitors 181 to 184, generates a partial video for each of the monitors 181 to 184, and outputs the generated partial video to each of the monitors 181 to 184. An information processor 150 performs setting of display ranges of the monitors 181 to 184 and the like so that the video output device 100 generates the partial video.

The video output device 100 illustrated in FIG. 1 comprises an video input terminal 101, a first terminal 102A, a second terminal 102B, a third terminal 102C, a fourth terminal 102D, a communication module 103, and a control program 110.

The video input terminal 101 is a terminal for inputting the video. The video input terminal 101 may be a terminal of an interface that can transmit a video signal. For example, a high-definition multimedia interface (HDMI (registered trademark)) may be used.

The first terminal 102A to the fourth terminal 102D are terminals configured to be connected to a plurality of monitors. Each of the first terminal 102A to the fourth terminal 102D may be a terminal of an interface that can transmit video. For example, the high-definition multimedia interface (HDMI (registered trademark)) may be used. In the present embodiment, the first terminal 102A is connected to the first monitor 181. The second terminal 102B is connected to the second monitor 182. The third terminal 102C is connected to the third monitor 183. The fourth terminal 102D is connected to the fourth monitor 184.

The communication module 103 is a module configured to perform communication with other communication device wirelessly or in a wired manner. In the present embodiment, the communication module 103 can establish a connection for performing communication with a communication module 153 of the information processor 150.

The control program 110 is executed by a processor (not illustrated) of the video output device 100 and loaded on a memory (not illustrated) of the video output device 100 to make a video input module 111, a reception module 112, an extraction module 113, and an output module 114.

The video input module 111 is configured to input the video from an external device or a reception antenna.

The reception module 112 is configured to receive information from other communication device (for example, the information processor 150) connected via the communication module 103. For example, the reception module 112 receives, from the information processor 150, a display range of the video for each of the monitors. Here, the display range is in accordance with a positional relation among the monitors 181 to 184 specified based on a test pattern image displayed on each of the monitors 181 to 184.

The extraction module 113 is configured to extract a partial video in the received display range for each of the monitors from the video input from the video input module 111.

The output module 114 outputs the video to the monitors 181 to 184 that are connected via the terminals 102A to 102D. The video includes static image data and moving image data. To recognize the positional relation among the monitors 181 to 184, for example, the output module 114 outputs a test pattern image different for each terminal.

The output module 114 outputs, for example, partial video of each of the monitors to the monitors 181 to 184 connected via the terminals 102A to 102D. Here, the partial video is extracted by the extraction module 113.

The test pattern image output by the output module 114 in the present embodiment is image data for specifying the positional relation, the size, and a rotation angle of the monitors that display the test pattern image. The test pattern images are different from each other for each output destination, so that it is possible to identify which monitor is the first monitor 181 to the fourth monitor 184.

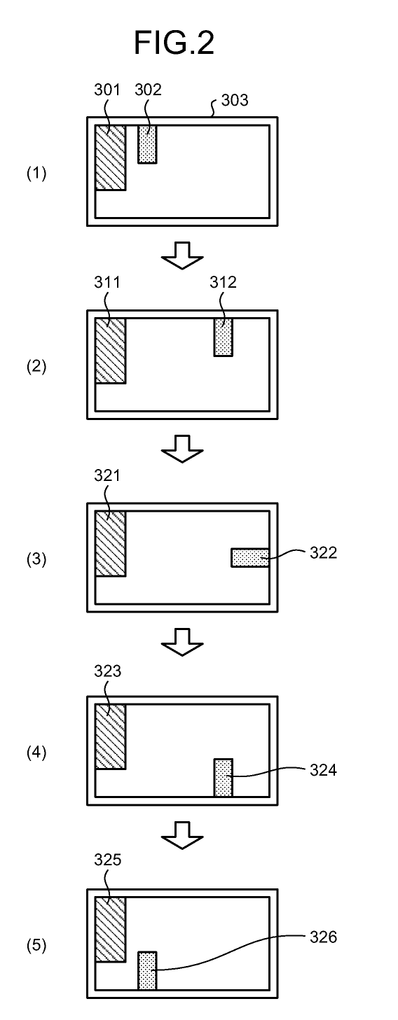

FIG. 2 is a diagram illustrating an example of the test pattern image output by the output module 114 in the present embodiment to the monitor. As illustrated in (1) of FIG. 2, the test pattern image includes a frame 303 for specifying the size of the monitor, a mark 301 representing a reference position, and a mark 302 for identifying the monitor that is different for each test pattern. In the present embodiment, the position of the mark for identifying the monitor is different for each monitor to which the image is output.

For example, in (2) of FIG. 2, a mark 312 for identifying the monitor is shifted to the right as compared to (1) of FIG. 2, with reference to a mark 311 representing the reference position. In (3) of FIG. 2, a mark 322 for identifying the monitor is provided at the right side, with reference to a mark 321 representing the reference position. In (4) of FIG. 2, a mark 324 for identifying the monitor is provided on the right of a lower side, with reference to a mark 323 representing the reference position. In (5) of FIG. 2, a mark 326 for identifying the monitor is provided on the left of the lower side, with reference to a mark 325 representing the reference position. In this way, as a number of the monitors that output the test pattern image increases, the test pattern image, in which the mark for identifying the monitor is provided at a position shifted from the mark representing the reference position in a clockwise direction, is output. The test pattern image is uniquely displayed for each of the monitors as described above. Accordingly, when the monitors 181 to 184 displaying the test pattern image is photographed, a relative positional relation among the monitors 181 to 184 can be specified while identifying the monitors 181 to 184 displaying the test pattern image based on the acquired image.

As illustrated in (1) to (5) of FIG. 2, a frame (for example, the frame 303) is provided to the test pattern image. The frame is displayed in a manner adjacent to the frame of the monitor, so that the size of the display region of each monitor can be specified.

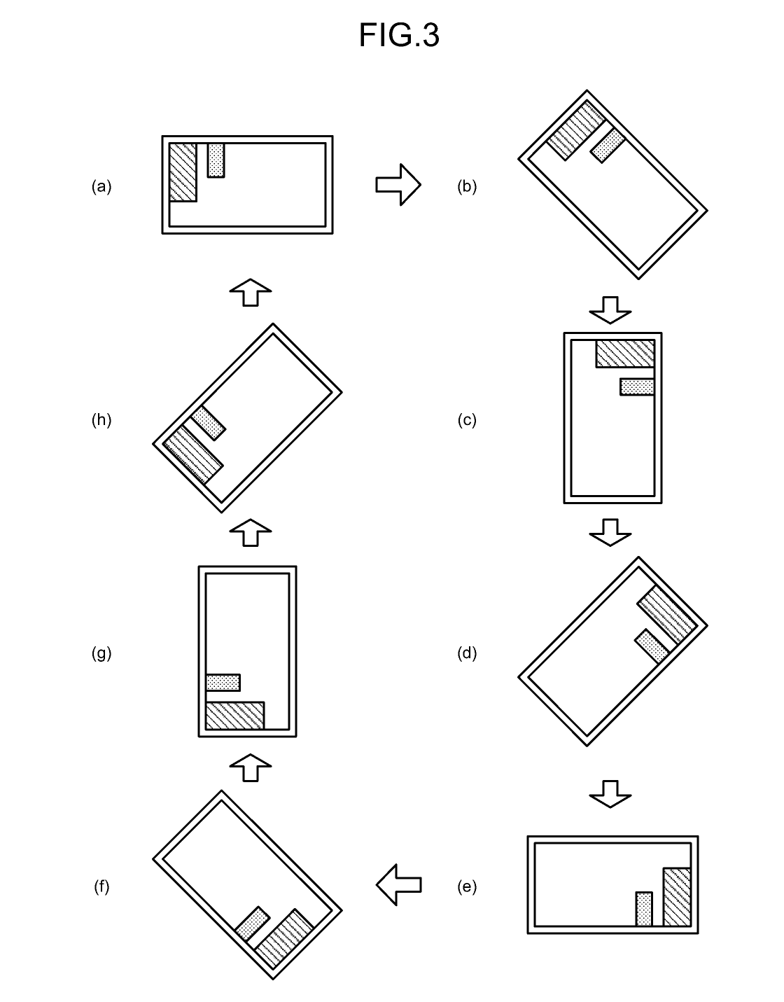

In the present embodiment, a rotational direction of the monitors 181 to 184 can be specified based on the test pattern image. FIG. 3 is a diagram illustrating an example of rotation of the test pattern image output by the output module 114 in the present embodiment to the monitors 181 to 184. In the example illustrated in FIG. 3, the test pattern image is rotated by 45 degrees at a time from (a) to (h) of FIG. 3. As illustrated in (a) to (h) of FIG. 3, an angle of the test pattern image can be uniquely specified based on the frame and the two marks within the frame, so that the rotational direction of the monitor can be specified.

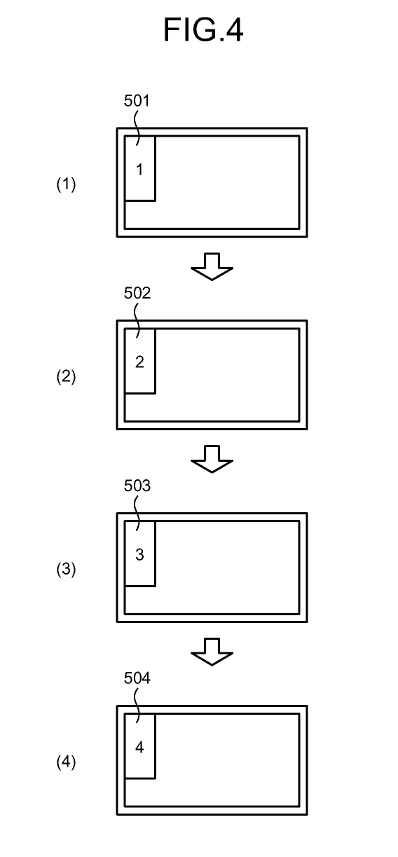

The test pattern image is not limited to the one that can uniquely identify the monitor using a combination of figures as described in the present embodiment. The monitor may be identified using a numerical value, a character string, or the like. FIG. 4 is a diagram illustrating an example of the test pattern image output by the output module 114 in a modification to the monitor. In the example of FIG. 4, the number of monitors connected to the video output device 100 is increased to four. As illustrated in FIG. 4, an identification number ‘1’ is displayed in a region 501 of a test pattern image (1), an identification number ‘2’ is displayed in a region 502 of a test pattern image (2), an identification number ‘3’ is displayed in a region 503 of a test pattern image (3), and an identification number ‘4’ is displayed in a region 504 of a test pattern image (4). In this way, the identification number displayed in the test pattern image is increased corresponding to the connection order. In the modification, the numerical value displayed in the test pattern image is analyzed to identify each monitor.

The modification describes an example of using characters such as the identification number for individual identification. Alternatively, a “bar code” or an “individual identification symbol” may be used. In the modification, individual identification of each monitor is not performed using a position of the mark as described in the embodiment, but using an image recognition technology with a character, a bar code, and a symbol.

As illustrated in FIG. 1, the information processor 150 comprises an image acquiring module 151, a touch panel display module 152, the communication module 153, and a control program 160. An image acquired by the image acquiring module 151 is processed by the control program 160. In the example of the present embodiment, a tablet terminal is used as the information processor 150. In the present embodiment, an information processing terminal is not limited to the tablet terminal. Alternatively, a cellular telephone terminal, a smart phone, and the like may be used. The information processor 150 of the present embodiment is used for specifying the relative positional relation among the monitors to notify the video output device 100 of the display range of the video for each of the monitors.

The touch panel display module 152 displays the image and the like on a liquid crystal panel, and detects an operation on the image and the like displayed on the liquid crystal panel via the touch panel by providing the touch panel to cover the liquid crystal panel.

The communication module 153 is a module configured to perform communication with other communication device wirelessly or in a wired manner. In the present embodiment, the communication module 153 can establish a connection for performing communication with the communication module 103 of the video output device 100.

The control program 160 is executed by a processor (not illustrated) of the information processor 150 and loaded on a memory of the information processor 150 to make an input module 161, a display module 162, a reception module 163, a setting module 164, and a transmission module 165.

The input module 161 is configured to input an image acquired by the image acquiring module 151. In the image acquired by the image acquiring module 151, for example, a plurality of monitors on which the test pattern image different for each of the monitors are displayed are visible.

The setting module 164 is a module for setting the display range of the video for each of the monitors based on the relative positional relation among the monitors. Accordingly, the setting module 164 in the present embodiment specifies the relative positional relation among the monitors 181 to 184 from the test pattern image included in the image input by the input module 161 (image data acquired by the image acquiring module 151). The setting module 164 also specifies the size and the rotational direction of the monitor. The setting module 164 sets the display range of the monitors 181 to 184, in accordance with the relative positional relation among the monitors 181 to 184, and the size and the rotational direction of the monitor.

The display module 162 is configured to display various types of data on the touch panel display module 152. The display module 162 displays the display range of the monitors 181 to 184 set by the setting module 164, and an output range of the video output from the video output device 100.

The reception module 163 receives an operation for setting a display range of video of each of the monitors 181 to 184, in accordance with the output range displayed on the display module 162 and the display range specified based on the relative positional relation among the monitors 181 to 184.

The setting module 164 sets the display range of the video of each of the monitors 181 to 184 in accordance with the operation received by the reception module 163.

The transmission module 165 transmits the display range of the video of each of the monitors to the video output device 100 so as to display the video while using the monitors 181 to 184 in combination. Accordingly, the display range of the video of each of the monitors based on the relative positional relation among the monitors is transmitted to the video output device 100. Here, the positional relation is specified based on the test pattern image displayed on the image acquired by the image acquiring module 151.

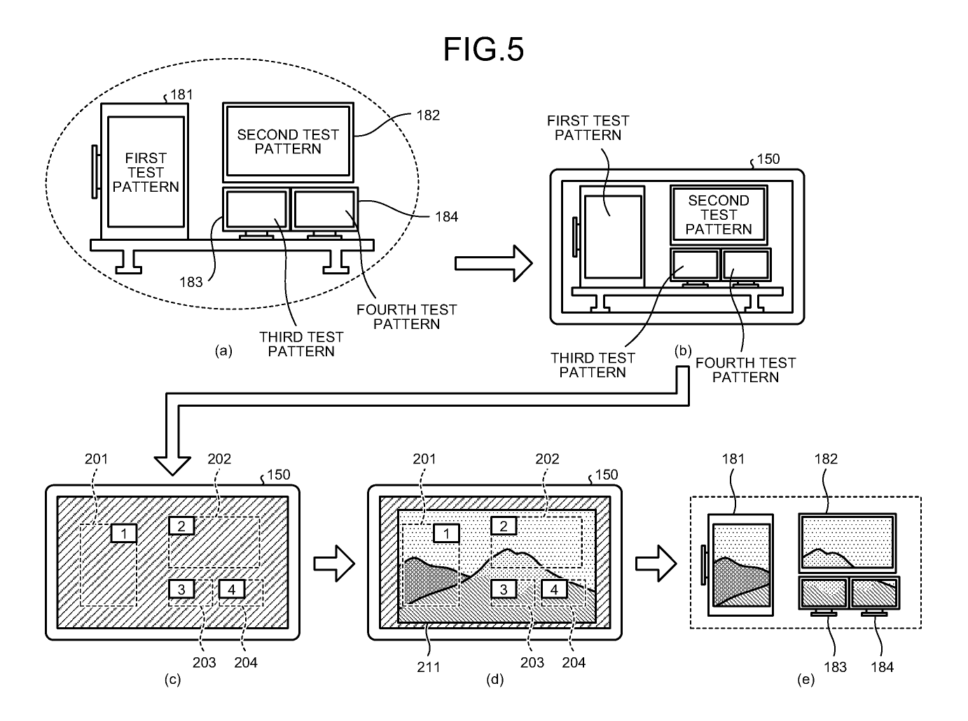

FIG. 5 is a diagram illustrating an example of transition of processing performed by the information processor 150 in the first embodiment. In an example of (a) of FIG. 5, the display system for displaying the video is constructed by combining the first monitor 181, the second monitor 182, the third monitor 183, and the fourth monitor 184. The first monitor 181 displays a first test pattern image. The second monitor 182 displays a second test pattern image. The third monitor 183 displays a third test pattern image. The fourth monitor 184 displays a fourth test pattern image. The first to the fourth test pattern images are pattern images that are only different in the position of the mark illustrated in FIG. 2.

As illustrated in (b) of FIG. 5, the image acquiring module 151 of the information processor 150 acquires an image of the display system. The input module 161 inputs the image acquired by the image acquiring module 151.

As illustrated in (c) of FIG. 5, the setting module 164 specifies the relative positional relation among the monitors 181 to 184 from the image. The setting module 164 also specifies the size and the rotational direction of the monitors 181 to 184 in addition to the relative positional relation. The display module 162 displays display ranges 201 to 204 in which the relative positional relation, the rotational direction, and the size of the monitors 181 to 184 can be specified. In the example illustrated in (c) of FIG. 5, the rotational direction of each monitor can be identified based on the position of identification information for each of the monitors.

As illustrated in (d) of FIG. 5, the display module 162 superimposes and displays the display ranges 201 to 204 of the monitors 181 to 184 on an output range 211 of the video. The reception module 163 receives an operation to change the output range 211 of the image and the display ranges 201 to 204 of the monitors 181 to 184 through a drag operation and the like from the touch panel display module 152. Accordingly, the setting module 164 sets the display ranges of the monitors 181 to 184 again in accordance with the change operation. The transmission module 165 transmits information for identifying the display ranges of the monitors 181 to 184 to the video output device 100. The information for identifying the display ranges includes position coordinates representing the display ranges of the video displayed on the monitors 181 to 184, sizes representing the display ranges, and the like.

As illustrated in (e) of FIG. 5, the video output device 100 outputs a partial video extracted from the input video for each of the monitors 181 to 184 in accordance with the information for identifying the display ranges of the monitors 181 to 184 transmitted from the information processor 150.

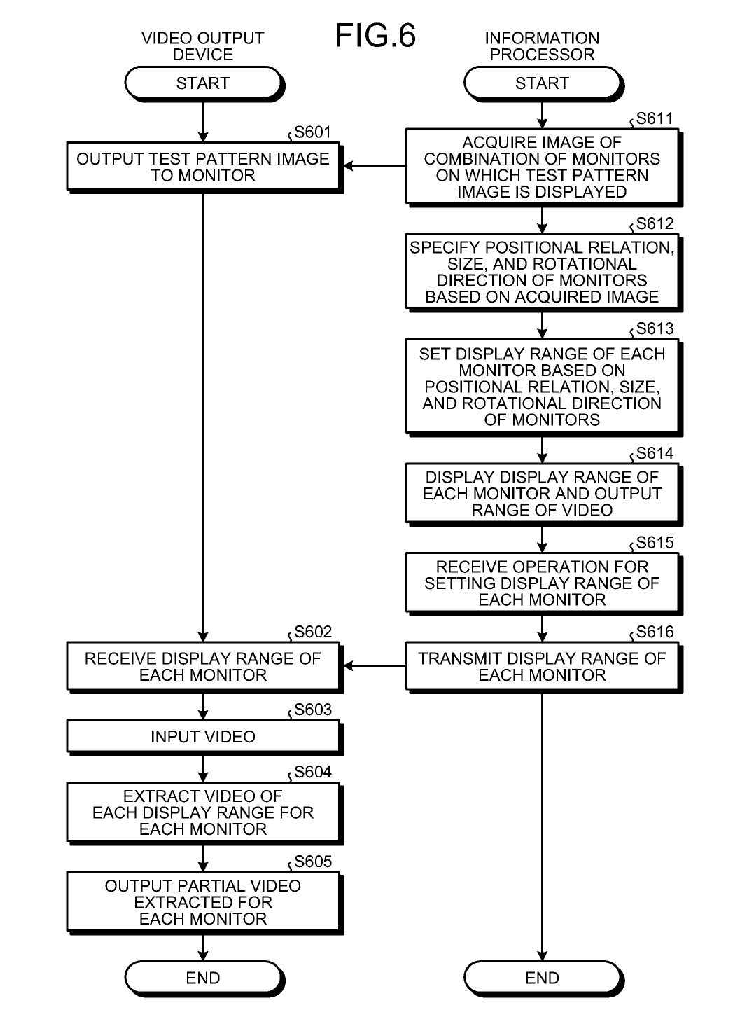

The following describes processing in the video output device 100 and the information processor 150 until the video is output, according to the present embodiment. FIG. 6 is a flowchart of a processing procedure described above in the video output device 100 and the information processor 150 in the present embodiment.

First, the output module 114 of the video output device 100 outputs the test pattern image to the monitors 181 to 184 via the terminals 102A to 102D (S601).

The image acquiring module 151 of the information processor 150 acquires an image of a combination of the monitors 181 to 184 (S611). Here, each of the monitors 181 to 184 displays the test pattern image. The setting module 164 specifies the positional relation among the monitors 181 to 184, the size, and the rotational direction thereof from the acquired image (S612). The setting module 164 sets the display range of the video of each of the monitors based on the positional relation among the monitors 181 to 184, the size, and the rotational direction thereof (S613).

The display module 162 of the information processor 150 displays the display range of each of the monitors 181 to 184 and the output range of the video (S614). The reception module 163 receives an operation for setting the display range of each of the monitors 181 to 184 (S615). Accordingly, the setting module 164 sets the display range of each of the monitors 181 to 184 again, in accordance with the operation.

The transmission module 165 transmits the display range of the video of each of the monitors 181 to 184 (S616).

The reception module 112 of the video output device 100 receives the display range of the video of each of the monitors 181 to 184 from the information processor 150 (S602).

The video input module 111 of the video output device 100 inputs the video (S603). The extraction module 113 extracts the input video in accordance with the display range of each of the monitors 181 to 184 (S604).

The output module 114 outputs, to each of the monitors, the partial video extracted for each of the monitors 181 to 184 (S605).

With the processing procedure described above, the video can be output in accordance with the relative positional relation among the monitors 181 to 184 that is specified by the information processor 150. With the processing procedure described above, it is not necessary to set a range of the video clipped by the user for each monitor to specify the relative positional relation among the monitors 181 to 184 based on the test pattern image, so that the operation burden can be reduced.

The first embodiment describes the example of specifying the relative positional relation among the monitors 181 to 184, the size of the display region of the monitors 181 to 184, and the rotational direction of the monitors 181 to 184, based on the test pattern image. However, it is not limited to specify all of the relative positional relation, the size of the display region, and the rotational direction. In other word, at least the positional relation may be specified. For example, when all of the monitors for constructing the display system are prepared in the same size, the size of the monitor needs not to be specified. When all of the monitors for constructing the display system are arranged at correct positions (without rotation), the rotational direction needs not to be specified.

### Modification of First Embodiment

The first embodiment describes the example in which the information processor 150 performs acquiring of an image and analyzes the acquired image. However, a device that performs the image acquiring does not need to be the same as a device that sets the display range of each monitor in accordance with the relative positional relation. A modification of the first embodiment describes an example of using a camera and a personal computer (PC) instead of the information processor 150. In the modification, the image acquired by the camera is output to the PC. Any method may be used as a method for outputting the image from the camera to the PC. For example, wireless communication may be used or a connection may be made with a communication cable.

The PC sets the display range of each monitor based on the input image. Because the method for setting the display range is similar to that of the first embodiment, description thereof will not be repeated. The PC transmits the set display range of each monitor to the video output device 100. Accordingly, the video output device 100 outputs a partial video in accordance with the relative positional relation for each monitor.

In the present modification, the PC specifies the relative positional relation among the monitors 181 to 184 and sets the display ranges in accordance with the relative positional relation. Alternatively, these may be performed by the video output device. In this case, the image acquired by the camera is input to the video output device. Then the video output device may specify the relative positional relation among the monitors, the size of the monitor, and the rotational direction of the monitor to set the display range of each monitor corresponding to the relative positional relation, the size of the monitor, and the rotational direction of the monitor.

### Second Embodiment

A second embodiment describes an example in which the information processor 150 adjusts color or luminance of the monitor.

Because the configuration of the video output device 100 and the information processor 150 in the second embodiment is similar to that of the first embodiment, description thereof will not be repeated.

The output module 114 of the video output device 100 performs processing similar to that of the first embodiment. The output module 114 specifies the display range of all of the monitors 181 to 184, and outputs the same pattern image to all of the monitors 181 to 184. The pattern image of the present embodiment is an image for adjusting color or luminance and represented by a gray pattern of the same signal level.

The reception module 112 of the video output device 100 receives information indicating a difference between colors (including luminance) of the monitors from the information processor 150.

When adjusting the video of each of the monitors, the extraction module 113 of the video output device 100 adjusts the color (for example, a luminance level) of the video in the display range of each of the monitors in accordance with the information indicating a difference between colors (including a luminance difference) of the monitors. For example, the adjustment is made such that video corrected by increasing the luminance level is output to a monitor having low luminance, and video corrected by decreasing the luminance level is output to a monitor having high luminance. Accordingly, the monitors can output video at the same luminance level. As a result, it can be achieved to display video with no sense of incongruity when the display system is constructed by combining the monitors 181 to 184 to display single video.

The input module 161 of the information processor 150 inputs an image in which the monitors 181 to 184 displaying the same pattern image are acquired. An example of the pattern image includes a gray pattern image of the same signal level.

The setting module 164 further calculates the difference between colors (luminance difference) of respective pattern images. The transmission module 165 transmits, to the video output device 100, the information indicating the difference between the colors of the monitors (luminance difference) calculated based on the difference between the colors of the pattern images, which is displayed on the image acquired by the image acquiring module 151. The relative positional relation among the monitors is specified through processing similar to that of the first embodiment, so that it is possible to specify to which of the monitors the color difference corresponds when the color difference is generated in the acquired image.

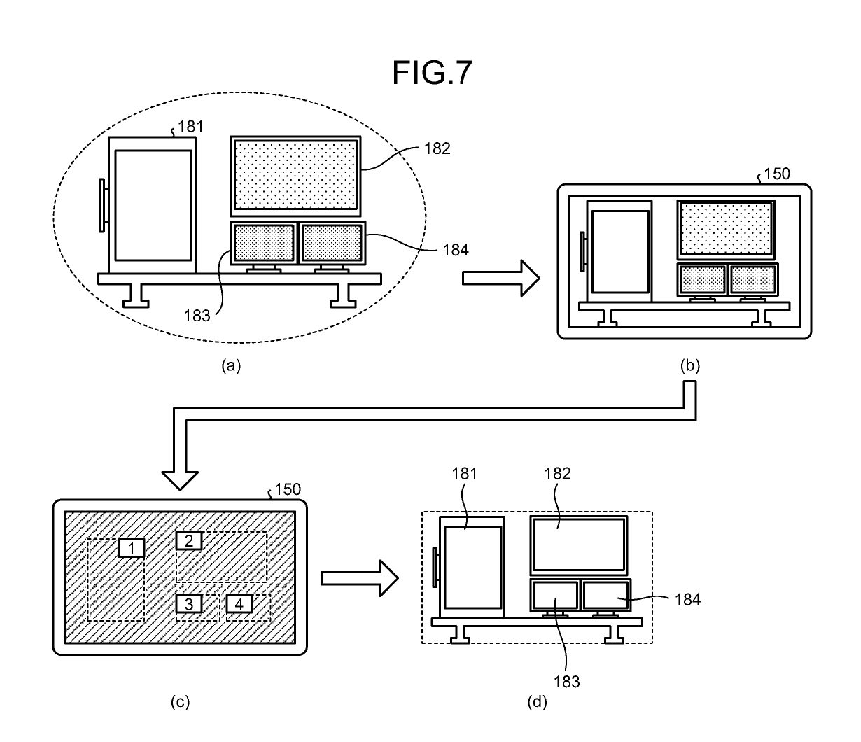

FIG. 7 is a diagram illustrating an example of transition of processing performed by the information processor 150 according to the second embodiment. In the example illustrated in (a) of FIG. 7, the same pattern image output from the video output device 100 is displayed on the first monitor 181, the second monitor 182, the third monitor 183, and the fourth monitor 184. However, different colors are displayed on the first monitor 181 to the fourth monitor 184. Accordingly, the colors of the first monitor 181 to the fourth monitor 184 may be preferably adjusted.

As illustrated in (b) of FIG. 7, the image acquiring module 151 of the information processor 150 acquires an image of the first monitor 181 to the fourth monitor 184. The input module 161 inputs the image acquired by the image acquiring module 151.

As illustrated in (c) of FIG. 7, the setting module 164 specifies the relative position, the rotational direction, and the size of the monitors 181 to 184 through the processing described in the first embodiment. Accordingly, the setting module 164 can specify the colors displayed on the monitors 181 to 184. The setting module 164 calculates the difference between the colors (including luminance) displayed on the monitors 181 to 184 based on the acquired image. The transmission module 165 transmits information indicating the difference between colors (including luminance) to the video output device 100.

As illustrated in (d) of FIG. 7, the video output device 100 adjusts the color (including luminance) of the pattern image to be output according to the received color difference displayed on the monitors 181 to 184, and outputs the adjusted video to each of the monitors 181 to 184. Accordingly, the monitors 181 to 184 display the pattern image that is adjusted corresponding to a characteristic of the monitor, so that it seems to the user that the same color is displayed.

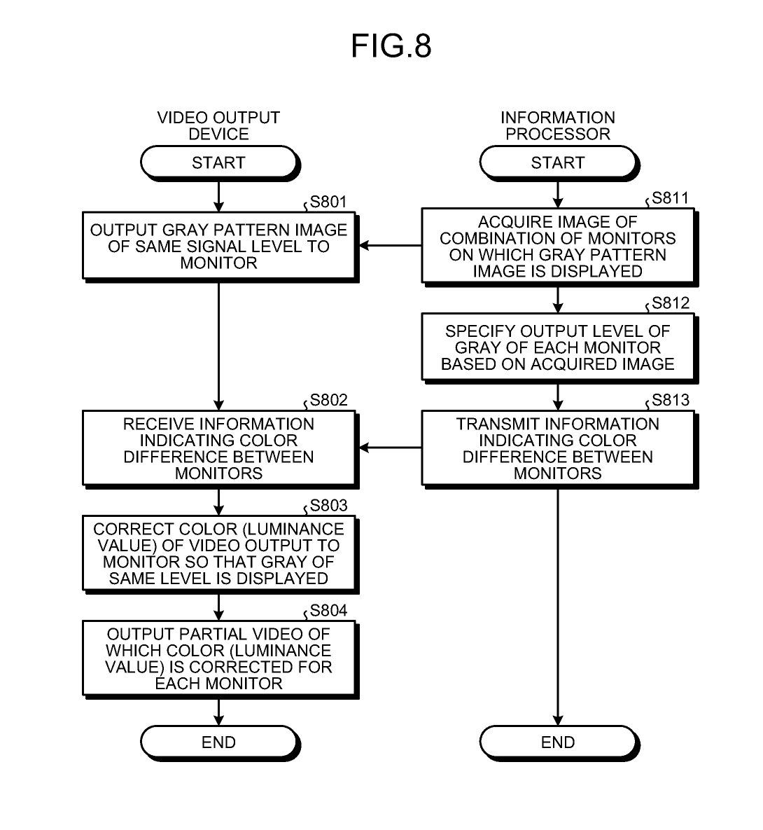

The following describes processing until the video is output in the video output device 100 and the information processor 150 in the present embodiment. FIG. 8 is a flowchart of the processing procedure described above in the video output device 100 and the information processor 150 in the present embodiment.

The output module 114 of the video output device 100 outputs a gray pattern image of the same signal level to the monitors 181 to 184 via the terminals 102A to 102D (S801).

The image acquiring module 151 of the information processor 150 acquires an image of a combination of the monitors 181 to 184 (S811). Here, each of the monitors 181 to 184 displays the gray pattern image. The setting module 164 specifies an output level of gray in the monitors 181 to 184 based on the acquired image (S812).

The transmission module 165 transmits information indicating a difference between the output levels of gray in the monitors 181 to 184, that is, a difference between colors displayed on the monitors 181 to 184 (for example, luminance information) (S813).

The reception module 112 of the video output device 100 receives the information indicating the difference between colors displayed on the monitors 181 to 184 (for example, luminance information) from the information processor 150 (S802).

The extraction module 113 corrects the color (luminance value) of the video (including the gray pattern image) displayed on the monitor so that gray of the same level is displayed (S803).

The output module 114 outputs the partial video of which color (luminance value) is corrected for each of the monitors 181 to 184, to each of the monitors at the same time (S804).

The color difference between the monitors 181 to 184 is corrected through the processing procedure described above, so that displaying of the video can be achieved with no sense of incongruity to the user when single video is displayed on the monitors 181 to 184 while the monitors are used in combination.

In the present embodiment, with the above configuration, a luminance difference for each monitor can be corrected by adjusting the luminance level of the video output from the video output device 100 to each monitor.

### Modification of Second Embodiment

The second embodiment describes an example of outputting the gray pattern of the same signal level to all of the monitors 181 to 184 and making an adjustment. However, it is not limited to such an adjustment method. For example, a difference may be generated in a width of the luminance that can be displayed on the monitors 181 to 184. The output module 114 of the video output device 100 outputs a gradation pattern image that is changed from black to white to the monitors 181 to 184 so that the correction can be made even in the case as described above.

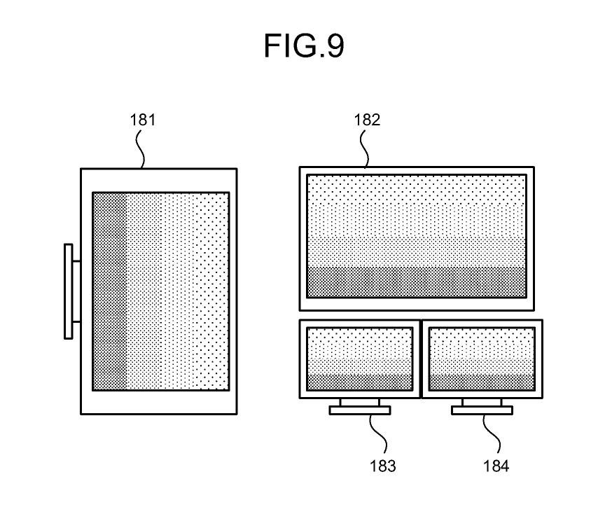

FIG. 9 is a diagram illustrating an example in which the monitors 181 to 184 display the pattern image output by the output module 114 in the modification. As illustrated in FIG. 9, the image acquiring module 151 of the information processor 150 acquires an image of the pattern image changed from white to black displayed on the monitors 181 to 184, and the setting module 164 compares colors at coordinates where the same luminance value should be displayed in the pattern image displayed on the monitors 181 to 184 and outputs the comparison result to the video output device 100. Accordingly, the width of the luminance displayed on the monitors 181 to 184 can be adjusted to be the same. Although the present modification describes a case of gradation from black to white, the display is not particularly limited. The monitors 181 to 184, for example, may display a pattern image including a plurality of color bars of different colors and may adjust color tones to be matched.

The embodiments and the modifications described above require no adjustment of the color of each monitor, thus making it possible to reduce the operation burden of the user.

Although the present embodiment describes a case of correcting the luminance difference as an example of color correction, it is not limited to the correction of the luminance difference. Alternatively, the color displayed on the monitor or brightness may be corrected. Irregularity of the luminance or color unevenness generated in a partial display region of the monitor may be corrected. Because the correction method is similar to that described above, description thereof will not be repeated.

In the present embodiment, because the color adjustment between the monitors that has been manually performed can be automatically performed by combining pieces of processing in the information processor and the video output device, the burden of the user for adjustment can be reduced.

### Third Embodiment

In the first and the second embodiments, inclination of the monitors 181 to 184 in the acquired image is not taken into account. A third embodiment describes an adjustment method in a case in which the monitors 181 to 184 are inclined in the acquired image due to camera shake or a way of holding the camera.

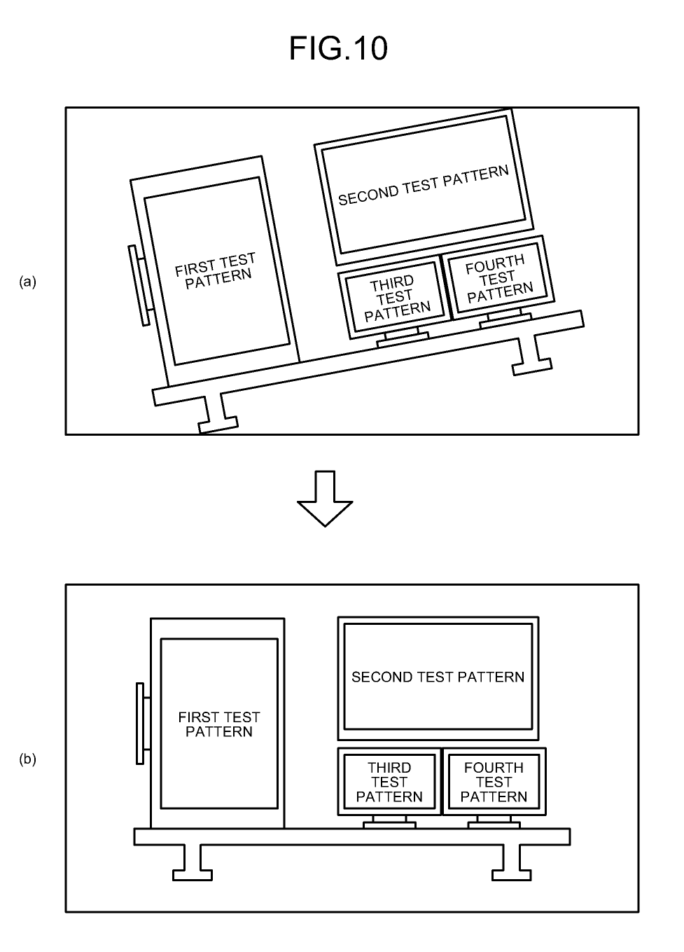

FIG. 10 is a diagram illustrating an example of adjusting the inclination based on the image acquired by the image acquiring module 151 in the information processor 150 according to the present embodiment. As illustrated in (a) of FIG. 10, the display module 162 displays the acquired image. Accordingly, it is recognized that the acquired image is inclined. When the display range of the monitors 181 to 184 is set based on such an inclined image, inclined video is displayed. Thus, the reception module 163 receives an operation for adjusting the inclination of the image illustrated in (a) of FIG. 10. An example of the operation may include an operation for rotating the image by a finger, and the like. With this operation, the display module 162 displays an image as illustrated in (b) of FIG. 10. Accordingly, the user can confirm that the inclination is adjusted. Thereafter, the monitors 181 to 184 display the video through processing similar to that of the embodiments described above.

### First Modification of Third Embodiment

The third embodiment describes an example of adjusting the inclination of the image through the operation by the user. However, it is not limited to the method for adjusting the inclination through the operation by the user. A first modification of the third embodiment describes an example of acquiring an image of the monitors 181 to 184 with a tool serving as a horizontal reference.

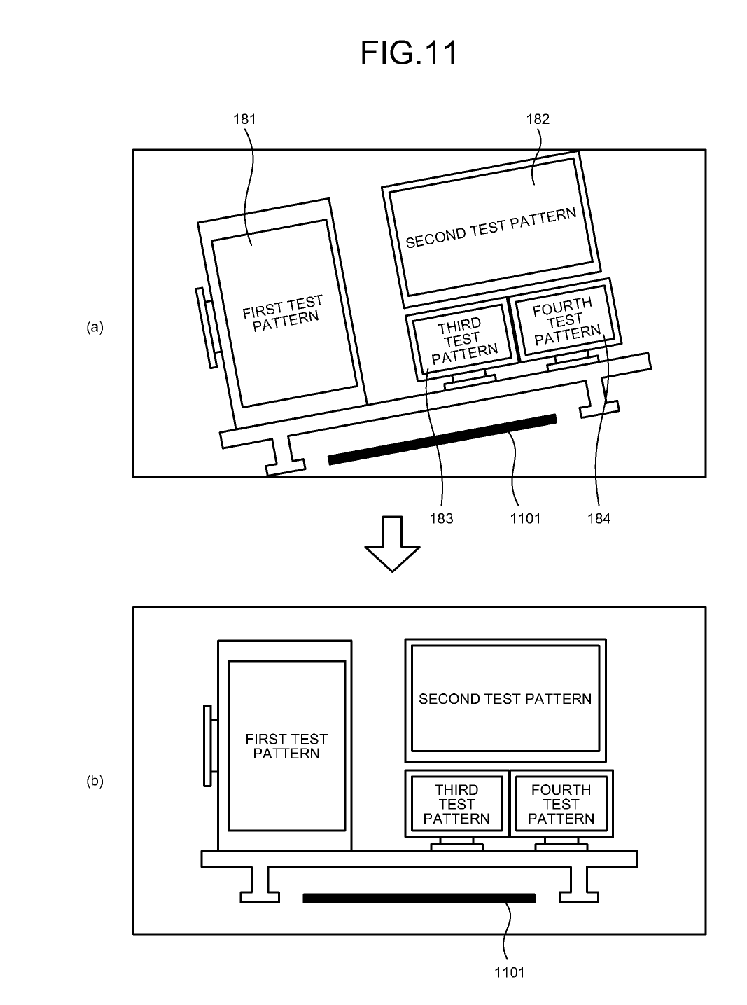

FIG. 11 is a diagram illustrating an example of adjusting the inclination based on the image acquired by the image acquiring module 151 in the information processor 150 in the present modification. As illustrated in (a) of FIG. 11, the display module 162 displays the acquired image. In this image, a tool 1101 serving as the horizontal reference appears in addition to the monitors 181 to 184. The setting module 164 can recognize that the acquired image is inclined based on an inclination of the tool 1101. The setting module 164 makes an adjustment for rotating the acquired image. With such an adjustment, the display module 162 displays an image as illustrated in (b) of FIG. 11. The user can confirm that the inclination is adjusted because the tool 1101 is acquired to be horizontal. Thereafter, the monitors 181 to 184 display the video through processing similar to that of the embodiments described above. Although the present modification describes an example of adjusting the inclination by using the setting module 164, the inclination may be adjusted by a module (for example, an adjustment module) different from the setting module 164.

### Second Modification of Third Embodiment

A second modification of the third embodiment describes an example of displaying a figure serving as the horizontal reference on a monitor that is horizontally arranged.

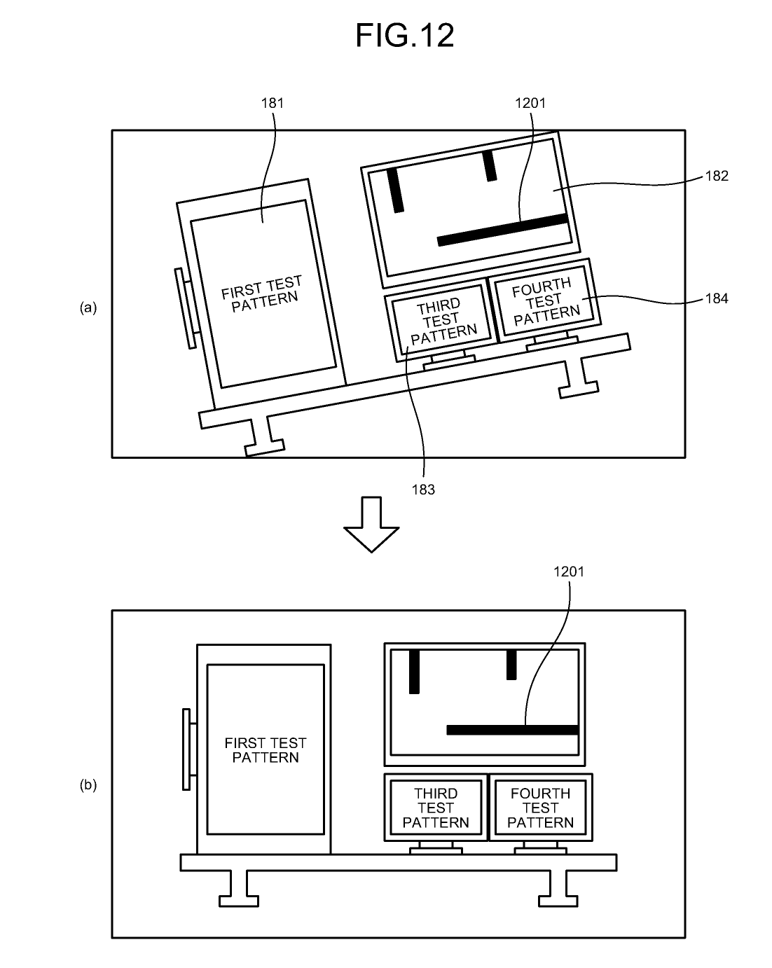

FIG. 12 is a diagram illustrating an example of adjusting the inclination based on the image acquired by the image acquiring module 151 in the information processor in the present modification. As illustrated in (a) of FIG. 12, the display module 162 displays the acquired image. In this image, the monitors 181 to 184 are visible. In (a) of FIG. 12, it is assumed that the monitor 182 is arranged such that a lower side thereof is horizontal. Accordingly, in the modification, the adjustment is made with reference to the arrangement of the monitor 182. Then the video output device 100 outputs, to the monitor 182, a pattern image including a FIG. 1201 serving as the horizontal reference. Accordingly, the monitor 182 displays the FIG. 1201.

The setting module 164 of the information processor 150 can recognize that the acquired image is inclined based on the inclination of the FIG. 1201 displayed on the monitor 182. The setting module 164 makes an adjustment for rotating the acquired image (correction of the inclination). With this adjustment, the display module 162 displays an image as illustrated in (b) of FIG. 12. The user can confirm that the inclination is corrected because the FIG. 1201 is acquired to be horizontal. Thereafter, the monitors 181 to 184 display the video through processing similar to that of the embodiments described above.

In the present embodiment, by correcting the rotation as described above, it is possible to correct the rotation generated due to camera shake during photographing or the inclination of the image acquiring module 151 in image acquiring.

According to the conventional technique, an assumed positional relation, size, and rotation angle of the monitors have been manually input. However, according to the above embodiments, adjustment can be made rapidly and easily by using the test pattern and the information processor. Accordingly, it is possible to immediately cope with a change of a position or rotation of the monitor.

That is, in the embodiment described above, an assumed positional relation, size, and rotation angle of the monitor are specified based on an image obtained by acquiring an image of a plurality of monitors, so that the burden of the user for setting can be reduced when single video is displayed by a display system in which monitors of which size and the rotational direction are free are freely arranged.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video output device comprising:
a plurality of terminals configured to be connected to a plurality of monitors;
an output module configured to output first images different for each of the terminals;
an input module configured to input video;
a reception module configured to receive, from an information processor, a display range of the video of each of the monitors, the display range being in accordance with a positional relation between the monitors specified based on the first images displayed on the monitors; and
an extraction module configured to extract a part of the video within the display range of the each of the monitors, the part of the video being to be output from the output module via one of the terminals.

2. The video output device of claim 1, wherein
the output module is further configured to output, to the terminals, second images common between the monitors,
the reception module is further configured to receive, from the information processor, information indicating a difference in colors displayed on the monitors and specified based on the second images, and
the video output device further comprises an adjustment module configured to adjust, in accordance with the information indicating the difference in colors between the monitors, colors of the video within the display range of the each of the monitors.

3. The video output device of claim 1, wherein each of the first images output by the output module is configured to be capable of identifying at least one of a rotation angle of one of the monitors on which the each of the first images is displayed and a size of a display region of the one of the monitors.

4. An information processor comprising:
an input module configured to input an acquired image acquired by acquiring an image of a plurality of monitors when the monitors are displaying first images different for each of the monitors; and
a transmission module configured to transmit, to a video output device connectable to the monitors, a display range of video for each of the monitors, the monitors being for displaying the video when used in combination, the display range being set based on a relative positional relation between the monitors specified based on the first images displayed within the acquired image.

5. The information processor of claim 4, wherein the transmission module is configured to transmit, to the video output device, the display range for each of the monitors, the display range being set based on at least one of a size of a display region and a rotational direction of each of the monitors specified based on the first images displayed within the acquired image.

6. The information processor of claim 4, comprising:
a display module configured to display the display range of the video of each of the monitors and an output range of the video; and
a reception module configured to receive an operation for setting the output range displayed on the display module and the display range of the video of the each of the monitors.

7. The information processor of claim 4, wherein
the input module is further configured to input a second image acquired by acquiring images of a plurality of monitors when the second images are displayed on the monitors, and
the transmission module is configured to transmit, to the video output device, information indicating a color difference between the monitors that is specified based on the second image and displayed on the second image.

8. The information processor of claim 4, further comprising:
an adjustment module configured to adjust inclination of the monitors displayed in the first image, in accordance with the first image input by the input module, wherein
the transmission module is configured to transmit, to the video output device, the display range of the video of each of the monitors, the display range being set based on a relative positional relation between the monitors specified based on the first image adjusted by the adjustment module.

9. A method comprising:
outputting first images different for each of a plurality of terminals configured to be connected to a plurality of monitors;
inputting video;
receiving, from an information processor, a display range of the video of each of the monitors, the display range being in accordance with a positional relation between the monitors specified based on the first images displayed on the monitors; and
extracting a part of the video within the display range of the each of the monitors, the part of the video being to be output via one of the terminals.
